(19) United States
(12) Patent Application Publication
(10) Pub. No.: US 2026/0369603 A1
(43) Pub. Date: Nov. 19, 2026

(54) DRY ELECTRODE MIXTURE, CATHODE, ALL-SOLID-STATE BATTERY, AND METHOD FOR MANUFACTURING ELECTRODE

(71) Applicants: HYUNDAI MOTOR COMPANY, Seoul (KR); Kia Corporation, Seoul (KR)

(72) Inventors: Ju Young JANG, Hwaseong-si (KR); Hyo Min YOO, Hwaseong-si (KR); Ik Hyeon CHOI, Hwaseong-si (KR); Byung Yong LEE, Hwaseong-si (KR); Hyun Jeong KIM, Hwaseong-si (KR)

(73) Assignees: HYUNDAI MOTOR COMPANY, Seoul (KR); Kia Corporation, Seoul (KR)

(21) Appl. No.: 19/369,936

(22) Filed: Oct. 27, 2025

(30) Foreign Application Priority Data
May 13, 2025 (KR) 10-2025-0062144

(51) Int. Cl. H01M 4/62; H01M 4/02; H01M 4/04; H01M 4/131; H01M 4/1391

(52) U.S. Cl. CPC H01M 4/62; H01M 4/0404; H01M 4/0435; H01M 4/131; H01M 4/1391; H01M 4/623; H01M 2004/028

(57) ABSTRACT

Disclosed are a dry electrode mixture, which includes a crystalline solid electrolyte, an active material, and a fibrous binder, in which the crystalline solid electrolyte has a sheer stress ranging from 1.0 kPa to 2.8 kPa under 2 kPa, a cathode, an all-solid-state battery, and a method for manufacturing the all-solid-state battery.

### CROSS-REFERENCE TO RELATED APPLICATION

This application claims the benefit of priority to Korean Patent Application No. 10-2025-0062144, filed in the Korean Intellectual Property Office on May 13, 2025, the entire contents of which are incorporated herein by reference in its entirety.

### TECHNICAL FIELD

The present disclosure relates to a dry electrode mixture, capable uniformly dispersing an electrode material even if a solvent is absent, a cathode and an all-solid-state battery, which are manufactured from the dry electrode mixture, and a method for manufacturing an electrode using the dry electrode mixture.

### BACKGROUND

Secondary batteries have recently been widely adopted across various industries, including electric vehicles and portable electronic devices. Among these, all-solid-state batteries have attracted significant attention due to their potential to achieve higher energy density. These batteries aim to enhance both safety and performance—specifically energy density and lifespan—by replacing conventional liquid electrolytes with solid electrolytes. This shift addresses key limitations of liquid-based systems, such as leakage risks and thermal instability, while paving the way for more compact and durable energy storage solutions.

In the manufacturing of all-solid-state batteries, the conventional wet electrode process—where a binder is dissolved in a solvent to form a slurry—presents several drawbacks. This method requires both a drying step and a post-treatment process to remove residual solvents, which increases production complexity and cost. Moreover, the use of organic solvents raises environmental concerns due to emissions and waste disposal requirements. As a result, the dry electrode process, which eliminates the need for solvents altogether, has emerged as a promising alternative for electrode fabrication.

The dry electrode process offers several advantages over the wet process. By omitting solvents, it eliminates the need for drying and post-treatment steps, thereby simplifying the manufacturing workflow and reducing energy consumption. This streamlined approach enables faster production cycles and supports scalability for mass production. Additionally, the absence of solvents minimizes environmental impact, aligning with sustainability goals in battery manufacturing. However, the dry process introduces new challenges, particularly in achieving uniform dispersion of the binder. Without the solvent to facilitate mixing, the binder may not evenly integrate with the active material and conductive additives. This can result in poor mechanical cohesion within the electrode, leading to reduced structural integrity and diminished electrochemical performance.

To address these challenges, studies have investigated various strategies to improve binder dispersibility in dry electrode fabrication. These include optimizing the binder's particle size and molecular weight, adjusting the mixing sequence, and modifying processing conditions. While these approaches have shown partial success, irregular binder distribution remains a persistent issue, often leading to inconsistent electrode quality and reduced performance. Thus, there is a need for improved dry electrode technologies that ensure uniform binder dispersion, enabling reliable, high-performance all-solid-state batteries suitable for commercial-scale production.

### SUMMARY

In aspects, the present disclosure provides a dry electrode mixture, a cathode, an all-solid-state battery, and a method for manufacturing an electrode, capable of improving the irregular distribution of the binder in the dry electrode.

To solve the problem, the present disclosure provides a dry electrode mixture, a cathode, an all-solid-state battery, and a method for manufacturing an electrode.

In more detail, (1) the present disclosure provides a dry electrode mixture, which includes a crystalline solid electrolyte, an active material, and a fibrous binder, in which the crystalline solid electrolyte has a sheer stress ranging from 1.0 kPa to 2.8 kPa under 2 kPa.

(2) The present disclosure provides a dry electrode mixture, in which a solvent is substantially absent in the dry electrode mixture, in (1).

(3) The present disclosure provides a dry electrode mixture, in which the solid electrolyte comprises a sulfide-based solid electrolyte, in (1) or (2).

(4) The present disclosure provides a dry electrode mixture, in which the crystalline solid electrolyte has a flow function (FF) ranging from 4 to 7, in any one of (1) to (3).

(5) The present disclosure provides a dry electrode mixture, in which the crystalline solid electrolyte has an angle of internal friction ranging from 40° to 60°, in any one of (1) to (4).

(6) The present disclosure provides a dry electrode mixture, in which the crystalline solid electrolyte has a bulk density ranging from 0.40 g/ml to 0.58 g/ml, in any one of (1) to (5).

(7) The present disclosure provides a dry electrode mixture, in which the active material has a content ranging from 70 wt % to 90 wt %, based on a total weight of the dry electrode mixture, in any one of (1) to (6).

(8) The present disclosure provides a dry electrode mixture, in which the active material has a content ranging from 10 wt % to 20 wt %, based on a total weight of the dry electrode mixture, in any one of (1) to (7).

(9) The present disclosure provides a dry electrode mixture, in which the fibrous binder has a content ranging from 0.1 wt % to 5.0 wt %, based on a total weight of the dry electrode mixture, in any one of (1) to (8).

(10) The present disclosure provides a dry electrode mixture, in which the fibrous binder includes at least one selected from polytetrafluoroethylene (PTFE), polyvinylidene fluoride (PVDF), and a copolymer of PTFE or PVDF, in any one of (1) to (9).

(11) The present disclosure provides a dry electrode mixture, in which a degree of fibrillation calculated through following Equation 1 is at least 2, in any one of (1) to (10),

Degree of Fibrillation=(powder transfer energy at 11th cycle−powder transfer energy in first cycle)/10, [Equation 1]

in which the powder transfer energy in the Equation 1 is a value calculated through following Equation 2, when a mixture is fully filled in a vessel including a blade,

$${E}_{total} ( Powder transfer energy [ mJ ] ) = {\int }_{0}^{H} ( \frac{T}{Rtana} + F ) dH \qquad [ Equation 2 ]$$

in which, in Equation 2, ‘H’ denotes a measured depth [mm], ‘α’ denotes a spiral angle [°], ‘T’ denotes the torque applied to the blade [N·mm], ‘R’ denotes the diameter of the blade [mm], and ‘F’ denotes the measured force [N].

(12) The present disclosure provides a dry electrode mixture, in which the active material is a cathode active material, in any one of (1) to (11).

(13) The present disclosure provides a cathode which includes a cathode active material, a crystalline solid electrolyte, and a fibrous binder having a network.

(14) The present disclosure provides an all-solid-state battery including the cathode in (13) and an anode.

(15) The present disclosure provides a method for manufacturing an electrode, which includes mixing a crystalline solid electrolyte, an active material, and a fibrous binder under absence of a solvent to prepare an electrode mixture, forming an electrode film by pressing the electrode mixture; and attaching the electrode film to a metal current collector, in which the crystalline solid electrolyte has a sheer stress ranging from 1.0 kPa to 2.8 kPa under 2 kPa.

(16) The present disclosure provides a method for manufacturing an electrode, in which the pressing is performed through a roll pressing manner, in (15).

(17) The present disclosure provides a method for manufacturing an electrode, in which the pressing is performed at a temperature ranging from 60 °C to 120 °C, in (15) or (16).

(18) The present disclosure provides a method for manufacturing an electrode, in which the attaching is performed through a roll pressing manner, in any one of (15) to (17).

(19) The present disclosure provides a method for manufacturing an electrode, in which the attaching is performed at a temperature ranging from 40 °C to 100 °C, in any one of (15) to (18).

### BRIEF DESCRIPTION OF THE DRAWINGS

The above and other objects, features and advantages of the present disclosure will be more apparent from the following detailed description taken in conjunction with the accompanying drawings:

FIG. 1 is a graph illustrating sheer stress of a solid electrolyte employed according to an embodiment of the present disclosure and a comparative example;

FIG. 2A, FIG. 2B, and FIG. 2C are images of an electrode mixture captured through a scanning electron microscope (SEM) according to an embodiment of the present disclosure;

FIG. 3A, FIG. 3B, and FIG. 3C are images of an electrode mixture captured through a scanning electron microscope (SEM) according to a comparative example for the present disclosure; and

FIG. 4 is a graph illustrating powder shear energy of an electrode mixture according to an embodiment of the present disclosure and a comparative example.

### DETAILED DESCRIPTION

Hereinafter, the present disclosure will be described in detail.

Terms or words used in the present specification and the claims should not be interpreted as commonly-used dictionary meanings, but be interpreted as to be relevant to the technical scope of the present disclosure based on the fact that the inventor may properly define the concept of the terms to explain the invention in best ways.

### Dry Electrode Mixture

The present disclosure provides a dry electrode mixture including a crystalline solid electrolyte, an active material, and a fibrous binder.

Hereinafter, a dry electrode mixture according to the present disclosure will be described in more detail.

In embodiments, the electrode mixture according to the present disclosure is a mixture for manufacturing a dry electrode. Accordingly, the electrode mixture may include a solvent having content of at most 1 wt %, at most 0.95 wt %, at most 0.90 wt %, at most 0.85 wt %, at most 0.80 wt %, at most 0.75 wt %, at most 0.70 wt %, at most 0.65 wt %, at most 0.60 wt %, at most 0.55 wt %, at most 0.50 wt %, at most 0.45 wt %, at most 0.40 wt %, at most 0.35 wt %, at most 0.30 wt %, at most 0.25 wt %, at most 0.20 wt %, at most 0.15 wt %, at most 0.10 wt %, or at most 0.05 wt %, based on the total weight of the electrode mixture, or may not include the solvent actually.

In embodiments, the crystalline solid electrolyte is an inorganic solid electrolyte such as a sulfide-based solid electrolyte, an oxide-based solid electrolyte, a halide-based solid electrolyte, or a solid polymer electrolyte. Preferably, the first solid electrolyte may be a sulfide-based solid electrolyte.

In embodiments, the sulfide-based solid electrolyte is various typical sulfide-based solid electrolyte without a particular limitation. Preferably, the sulfide-based solid electrolyte may include at least one selected from Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which, ‘m’ and ‘n’ is positive numbers; Z is one of Ge, Zn, and Ga), Li₂S—GeS₂, Li₂S—SiS₂—Li₃PO₄, Li₂S—SiS₂-LiₓMO_{y} (in which ‘x’ and ‘y’ are positive numbers; ‘M’ is one among P, Si, Ge, B, Al, Ga, and In), and Li₁₀GeP₂Si₂.

In embodiments, the oxide-based solid electrolyte may be various typical oxide-based solid electrolytes without a particular limitation. Preferably, the oxide-based solid electrolytes may include at least one selected from Li_{1+x+y}AlₓTi₂₋ₓSi_{y}P_{3-y}O₁₂ (0<x<2, 0≤y<3), BaTiO₃, Pb(Zr,Ti)O₃(PZT), Pb₁₋ₓLaₓZr_{1-y}Ti_{y}O₃(PLZT) (0≤x<1, 0≤y<1), PB(Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (0<x<2, 0<y<3), LiₓAl_{y}Ti_{z}(PO₄)₃ (0<x<2, 0<y<1, 0<z<3), Li_{1+x+y}(Al, Ga)ₓ(Ti, Ge)₂₋ₓSi_{y}P_{3-y}O₁₂ (0≤x≤1, 0≤y≤1), LiₓLa_{y}TiO₃ (0<x<2, 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (M=Te, Nb, or Zr; 0≤x≤10), and Li₇La₃Zr₂₋ₓTaₓO₁₂ (0<x<2, LLZ-Ta)

In embodiments, the halide-based solid electrolyte may include a Li element, an M element (‘M’ is metal other than Li), and an ‘X’ element (‘X’ is halogen). The ‘X’, for example, may be F, Cl, Br, and I. Especially, the halide-based solid electrolyte may appropriately include, at least one of Br and Cl as the ‘X’. In addition, the ‘M’ may be a metal element, such as Sc, Y, B, Al, Ga, and In.

In embodiments, the solid electrolyte according to the present disclosure may have a crystalline structure to exhibit a regular form. Accordingly, as the bonding force with the fibrous binder is reduced, the dispersibility of the electrode mixture including the crystalline solid electrolyte and the fibrous binder may be increased. According to the present disclosure, the crystalline solid electrolyte may have shear stress of at least 1.0 kPa, at least 1.1 kPa, at least 1.2 kPa, at least 1.3 kPa, at least 1.4 kPa, at least 1.5 kPa, at least 1.6 kPa, at least 1.7 kPa, or at least 1.8 kPa, and at most 2.8 kPa, at most 2.7 kPa, at most 2.6 kPa, at most 2.5 kPa, at most 2.4 kPa, at most 2.3 kPa, at most 2.2 kPa, at most 2.1 kPa, at most 2.0 kPa, or at most 1.9 kPa, which is measured under 2 kPa. Within the above range, the shape of the crystalline solid electrolyte which is completely crystallized up to the surface of the solid electrolyte may be exhibited.

In embodiments, the solid electrolyte may have a flow function (FF) of at least 4, at least 4.1, at least 4.2, at least 4.3, at least 4.4, at least 4.5, at least 4.6, at least 4.7, at least 4.8, at least 4.9, or at least 5, and at most 7, at most 6.9, at most 6.8, at most 6.7, at most 6.6, at most 6.5, at most 6.4, at most 6.3, at most 6.2, at most 6.1, or at most 6. Within the range, cohesion between particles may be decreased. Accordingly, dispersibility of the electrode mixture may be increased.

An angle of internal friction (AIF) of the solid electrolyte may be at least 40 °C, at least 41 °C, at least 42 °C, at least 43 °C, at least 44 °C, at least 45 °C, at least 46 °C, at least 47 °C, at least 48 °C, at least 49 °C, or at least 50 °C, and at most 60 °C, at most 59 °C, at most 58 °C, at most 57 °C, at most 56 °C, at most 55 °C, at most 54 °C, at most 53 °C, at most 52 °C, or at most 51 °C. Within the range, cohesion between particles may be decreased. Accordingly, dispersibility of the electrode mixture may be increased.

In embodiments, the solid electrolyte may have the bulk density of at least 0.40 g/ml, at least 0.41 g/ml, at least 0.42 g/ml, at least 0.43 g/ml, at least 0.44 g/ml, at least 0.45 g/ml, at least 0.46 g/ml, or at least 0.47 g/ml, and at most 0.58 g/ml, at most 0.57 g/ml, at most 0.56 g/ml, at most 0.55 g/ml, at most 0.54 g/ml, at most 0.53 g/ml, at most 0.52 g/ml, at most 0.51 g/ml, at most 0.50 g/ml, at most 0.49 g/ml, or at most 0.48 g/ml. Within the range, cohesion between particles may be decreased. Accordingly, dispersibility of the electrode mixture may be increased.

According to the present disclosure, the active material included in the electrode mixture may be an anode active material, or a cathode active material. Preferably, the electrode mixture may include the cathode active material.

In embodiments, the anode active material may employ various materials without a particular limitation, as long as the materials are employed for a typical anode of the all-solid-state battery. For example, the anode active material may be carbon such as non-graphitizable carbon and graphite-based carbon; a metal composite oxide, such as LixFe₂O₃ (0≤x≤1), LixWO₂ (0≤x≤1), and SnₓMe₁₋ₓMe′_yO_z (in which Me is Mn, Fe, Pb, or Ge; Me′: Al, B, P, Si, a Group 1, 2, or 3 element of the periodic table, or a halogen; 0<x≤1; 1≤y≤3; 1≤z≤8); lithium metal; a lithium alloy; a silicon-based alloy; a tin-based alloy; a metal oxide, such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; a conductive polymer such as polyacetylene; and Li—Co—Ni-based materials.

In embodiments, the cathode active material may employ various materials without a particular limitation, as long as the materials are employed for a cathode of the all-solid-state battery. The cathode active material may include an oxide active material or a sulfide active material.

In embodiments, the oxide active material may include a rock salt type active material, such as LiCoO₂, LiMnO₂, LiNiO₂, LiVO₂, Li₁₊ₓNi_{1/3}Co_{1/3}Mn_{1/3}O₂, a spinel type active material, such as LiMn₂O₄, and Li(Ni_{0.5}Mn_{1.5})O₄, reverse spinel type active material, such as LiNiVO₄, or LiCoVO₄, an olivine-type active material, such as LiFePO₄, LiInPO₄, LiCoPO₄, or LiNiPO₄, a silicon-containing active material, such as Li₂FeSiO₄, or Li₂MnSiO₄, a rock salt type active material, such as LiNi_{0.8}Co_{(0.2-x)}AlₓO₂ (0<x<0.2), which is obtained by substituting a portion of transition metal with a heterogeneous metal, a spinel-type active material, such as Li₁₊ₓMn_{2-x-y}M_{y}O₄ (M is at least one of Al, Mg, Co, Fe, Ni, and Zn; 0<x+y<2), which is obtained by substituting a portion of the transition metal with a heterogeneous metal, or lithium titanate such as Li₄Ti₅O₁₂. In addition, the sulfide active material may be copper Chevrel, iron sulfide, cobalt sulfide, or nickel sulfide.

According to the present disclosure, the fibrous binder included in the electrode mixture may include a material which may form a network under pressure to allow the development to a fibrous structure, and the material may include selected from polytetrafluoroethylene (PTFE), polyvinylidene fluoride (PVDF), and copolymers of PTFE or PVDF. When the fibrous binder is appropriately selected, the mechanical strength of the electrode may be increased, and the ion conductivity and the electron conductivity may be improved.

According to the present disclosure, the electrode mixture may additionally include a conductive material. The conductive material may include various materials without a particular limitation, as long as the materials improve electron conductivity inside the electron. Preferably, the conductive material may include carbon black, conductive graphite, or ethylene black, graphene.

According to the present disclosure, the content of the active material included in the electrode mixture may be at least 70 wt %, at least 71 wt %, at least 72 wt %, at least 73 wt %, at least 74 wt %, at least 75 wt %, at least 76 wt %, at least 77 wt %, or at least 78 wt %, and at most 90 wt %, at most 89 wt %, at most 88 wt %, at most 87 wt %, at most 86 wt %, at most 85 wt %, at most 84 wt %, at most 83 wt %, or at most 82 wt %. Within the range, higher energy density may be maintained, and mechanical stability of an electrode manufactured from the electrode mixture may be increased.

According to the present disclosure, the crystalline solid electrolyte included in the electrode mixture may have the content of at least 10 wt %, at least 11 wt %, at least 12 wt %, at least 13 wt %, or at least 14 wt %, and at most 20 wt %, at most 19 wt %, at most 18 wt %, at most 17 wt %, or at most 16 wt %, based on the total weight of the dry electrode mixture. Within the range, the dispersibility of the electrode mixture may be increased, the contact of the electrode-electrolyte interface may be improved, and mechanical stability of the electrode manufactured from the electrode mixture may be increased.

According to the present disclosure, the fibrous binder included in the electrode mixture may have the content of at least 0.1 wt %, at least 0.2 wt %, at least 0.3 wt %, at least 0.4 wt %, at least 0.5 wt %, at least 0.6 wt %, at least 0.7 wt %, at least 0.8 wt %, at least 0.9 wt %, at least 1.0 wt %, at least 1.1 wt %, at least 1.2 wt %, at least 1.3 wt %, at least 1.4 wt %, or at least 1.5 wt %, and at most 5.0 wt %, at most 4.8 wt %, at most 4.6 wt %, at most 4.4 wt %, at most 4.2 wt %, at most 4.0 wt %, at most 3.8 wt %, at most 3.6 wt %, at most 3.4 wt %, at most 3.2 wt %, at most 3.0 wt %, at most 2.8 wt %, at most 2.6 wt %, at most 2.4 wt %, at most 2.2 wt %, or at most 2.0 wt %, based on the total weight of the dry electrode mixture. Within the range, the dispersibility of the electrode mixture may be increased, and the mechanical stability of the electrode manufactured from the electrode mixture may be increased.

According to the present disclosure, the electrode mixture may have the degree of fibrillation calculated through following Equation 1, and the degree of fibrillation may be at least 10, at least 10.5, at least 11, at least 11.5, at least 12, at least 12.5, at least 13, at least 13.5, at least 14, at least 14.5, or at least 15, and at most 30, at most 29.5, at most 29, at most 28.5, at most 28, at most 27.5, at most 27, at most 26.5, at most 26, at most 25.5, or at most 25.

Degree of Fibrillation=(powder transfer energy at 11th cycle−powder transfer energy in first cycle)/10 [Equation 1]

The powder transfer energy in the following Equation 1 is a value calculated through following Equation 2, when a mixture is fully filled in a vessel including a blade.

$${E}_{total} ( Powder transfer energy [ mJ ] ) = {\int }_{0}^{H} ( \frac{T}{Rtana} + F ) dH \qquad [ Equation 2 ]$$

In Equation 2, ‘H’ denotes a measured depth [mm], ‘α’ denotes a spiral angle [°], ‘T’ denotes the torque applied to the blade [N·mm], ‘R’ denotes the diameter of the blade [mm], and ‘F’ denotes the measured force [N].

### Cathode and Solid Electrolyte

The present disclosure may provide a cathode including a cathode active material, the crystalline solid electrolyte, and the fibrous binder having the network.

According to the present disclosure, the cathode may be manufactured from the above-described electrode mixture through a drying manner. Accordingly, the cathode active material and the crystalline solid electrolyte may be applied as described in the description about the dry electrode mixture. In addition, according to the present disclosure, the cathode may include the fibrous binder having a network formed as the fibrous binder is pressed. In this case, the fibrous binder may be applied as described in the description about the fibrous binder.

The present disclosure may provide the all-solid-state battery including the cathode and the anode, and at least one of the cathode or the anode may be manufactured from the dry electrode mixture.

### Method for Manufacturing Electrode

The present disclosure provides a method for manufacturing an electrode, which includes mixing the crystalline solid electrolyte, the active material, and the fibrous binder under the absence of a solvent to prepare the electrode mixture, forming an electrode film by pressing the electrode mixture; and attaching the electrode film to a metal current collector.

Hereinafter, the method for manufacturing the electrode according to the present disclosure will be described in detail.

According to the present disclosure, the method for manufacturing the electrode may include mixing the crystalline solid electrolyte, the active material, and the fibrous binder under the absence of the solvent to prepare the electrode mixture. The crystalline solid electrolyte, the active material, and the fibrous binder used in the present step may be applied as described in the description about the dry electrode mixture.

According to the present disclosure, the method for manufacturing the electrode may include forming the electrode film by pressing the electrode mixture. In the present step, the fibrous binder may be pressed to become additionally fibrous. Accordingly, the density of the electrode film may be increased. Specifically, the pressing under the present step may be performed through a roll pressing manner. Accordingly, the electrode film may be uniformly formed, and the electrode density may be increased.

The pressing may be performed at the temperature of at least 60 °C, at least 62 °C, at least 64 °C, at least 66 °C, at least 68 °C, at least 70 °C, at least 72 °C, at least 74 °C, at least 76 °C, at least 78 °C, or at least 80 °C, and at most 120 °C, at most 118 °C, at most 116 °C, at most 114 °C, at most 112 °C, at most 110 °C, at most 108 °C, at most 106 °C, at most 104 °C, at most 102 °C, or at most 100 °C. Within the above range, the fibrous binder may be efficiently fiberized, and the mechanical property of the electrode membrane may be increased.

According to the present disclosure, the method for manufacturing the electrode may include attaching the electrode film formed above to the metal current collector. Accordingly, the electrode according to the present disclosure may be manufactured.

The metal current collector may be an anode current collector or a cathode current collector. The anode current collector includes various materials without a particular limitation, as long as the materials are typically employed for the all-solid-state battery. For example, the material may preferably include at least one type selected from copper, stainless steel, aluminum, nickel, titanium, sintered carbon, a material obtained by performing surface-treatment for the surface of copper or stainless steel with carbon, nickel, titanium, or silver, and an aluminum-cadmium alloy.

In addition, the cathode current collector includes various materials without a particular limitation, as long as the materials are typically employed for the all-solid-state battery. For example, the material may include at least one selected from indium, copper, magnesium, aluminum, stainless steel, iron, and combinations thereof.

The attaching may be performed through the roll pressing manner. Accordingly, the mechanical adhesion between the electrode film and the current collector is increased, thereby decreasing interface resistance and increasing battery efficiency and a battery life.

The attaching may be performed at the temperature of at least 40 °C, at least 41 °C, at least 42 °C, at least 43 °C, at least 44 °C, at least 45 °C, at least 46 °C, at least 47 °C, at least 48 °C, at least 49 °C, or at least 50 °C, and at most 100 °C, at most 99 °C, at most 98 °C, at most 97 °C, at most 96 °C, at most 95 °C, at most 94 °C, at most 93 °C, at most 92 °C, at most 91 °C, at most 90 °C, at most 89 °C, at most 88 °C, at most 87 °C, at most 86 °C, at most 85 °C, at most 84 °C, at most 83 °C, at most 82 °C, at most 81 °C, or at most 80 °C. Within the range, the mechanical stability of the electrode may be further increased, thereby improving the efficiency and the lifespan of the battery.

Hereinafter, although embodiments and an experimental example will be described in more detail to describe the present disclosure in detail, the present disclosure is not limited to the embodiments and the experimental examples. Embodiments of the present disclosure may have various modifications, and the scope of the present disclosure is not limited to following embodiments. The embodiments of the present disclosure are provided to describe the present disclosure for those skilled in the art more completely.

### Embodiment

19 g of LPSCl solid electrolyte, 78 g of an NCM-based cathode active material, 1.5 g of a point-type conductive material, and 1.5 g of polytetrafluoroethylene (PTFE) were mixed through a high shear mixer under the absence of a solvent to prepare the electrode mixture. Thereafter, the electrode mixture was pressed through the roll pressing manner to form a cathode self-standing film. Then, the cathode self-standing film was stacked on an aluminum foil prepared separately and the result was roll-pressed through the roll pressing manner at the temperature of 80 °C, thereby manufacturing the cathode.

### Comparative Example

When comparing to the embodiment, the electrode mixture and the cathode were prepared through a manner the same as a manner employed in the embodiment, except that an LPSCl solid electrolyte having an amorphous surface and an internal crystalline structure were employed, instead of the crystalline solid electrolyte.

### Experimental Example 1: Measurement of Mechanical Properties of Solid Electrolyte

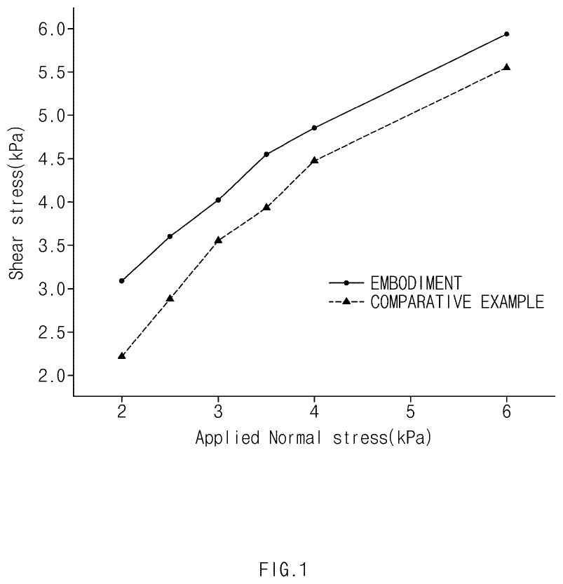

The mechanical properties of the solid electrolytes employed in the embodiment and the comparative example were measured through the following measuring manner and are shown in Table 1 and FIG. 1.

### [Measuring Manner]

Flow Function (FF; Flow Factor): After obtaining stress-shear stress data from six shear test points through FT4 Powder Rheometer (Microelectrics), and the yield lines of the six shear test points were derived. Thereafter, σ₁ (maximum main stress) and σ_{c} (unlimited yield stress) were calculated through the contact between the yield line and the Mohr circle, and the flow coefficient was calculated by the ratio of σ₁/σ_{c}.

Angle of Internal Friction [°]: an inclination angle was measured between the yield line (yield locus) derived from each of the six secured shear test points through FT4 Powder Rheometer (Micromeritics) and the vertical stress axis (x axis).

Bulk density [g/ml]: a sample was filled in a vessel, and compressed from the top under 6 kPa, and an upper protrusion was removed to measure the mass of the sample filled in a specified volume. Thereafter, the bulk density was then calculated by dividing the mass (g) of the sample by the volume (mL) of the vessel.

TABLE 1

| | F.F | A.I.F [°] | BD [g/ml] |
|---|---|---|---|
| Embodiment | 5.57 | 43.49 | 0.47 |
| Comparative | 3.04 | 37.71 | 0.60 |
| example | | | |

From table 1 and FIG. 1, it may be recognized that the crystalline solid electrolyte according to the embodiment of the present disclosure exhibited more excellent flow function and the greater angle of internal friction when compared to the amorphous solid electrolyte employed according to the comparative example. Accordingly, the crystalline solid electrolyte according to the embodiment of the present disclosure exhibited greater cohesion.

### Experimental Example 2: Evaluation for Mechanical Property and Outer Appearance of Electrode Mixture

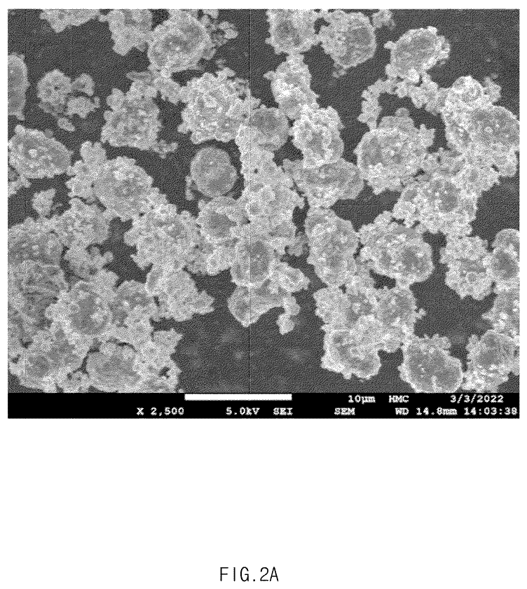

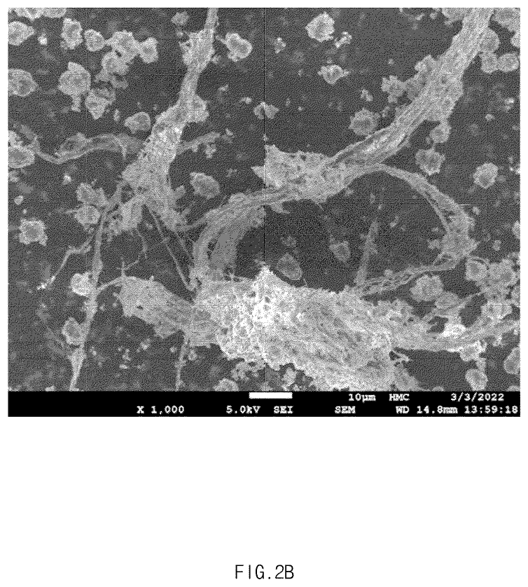

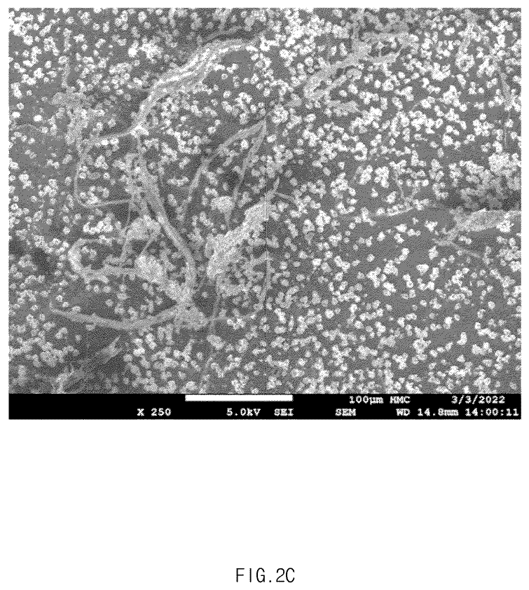

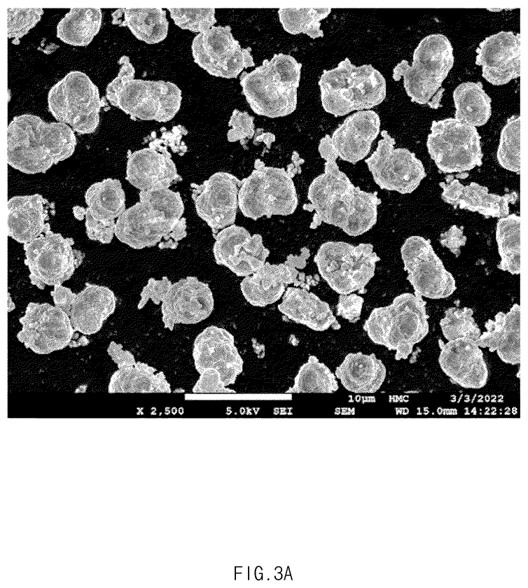

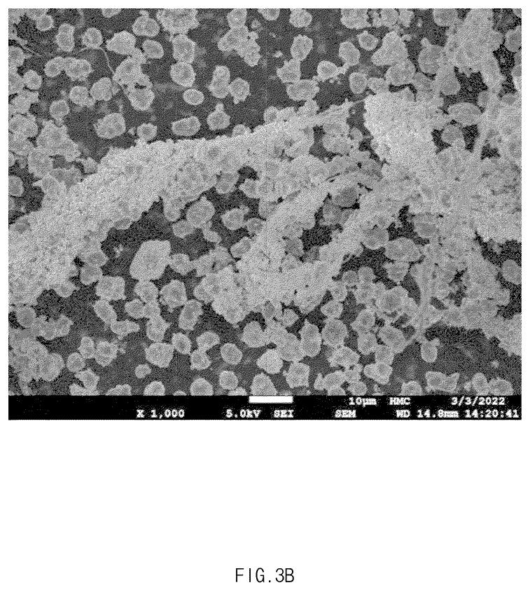

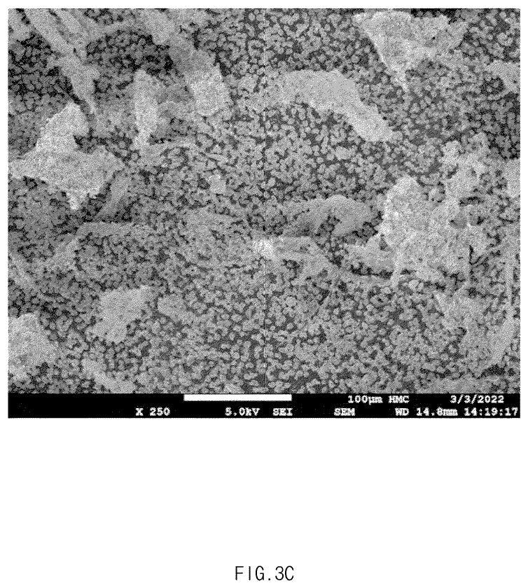

Scanning electron microscope (SEM) images were captured with respect to the electrode mixture prepared according to the embodiment and the comparative example and illustrated in FIG. 2A, FIG. 2B, and FIG. 2C, and FIG. 3A, FIG. 3B, and FIG. 3C.

It may be recognized through FIG. 2A, FIG. 2B, and FIG. 2C that the electrode mixture employed together with the solid electrolyte crystallized and the fibrous binder as in the present disclosure had a fibrosis in the fibrous binder during the mixing process, but the solid electrolyte and the fibrous binder were less bonded, such that the fibrous binder was present independently without the aggregation of the solid electrolyte. To the contrast, it may be recognized through FIG. 3A, FIG. 3B, and FIG. 3C that the electrode mixture employing the amorphous solid electrolyte had a fibrosis in the fibrous binder during the mixing process, but the fibrous binder and the solid electrolyte were present in an aggregated state, due to the higher cohesion between the solid electrolyte and the fibrous binder.

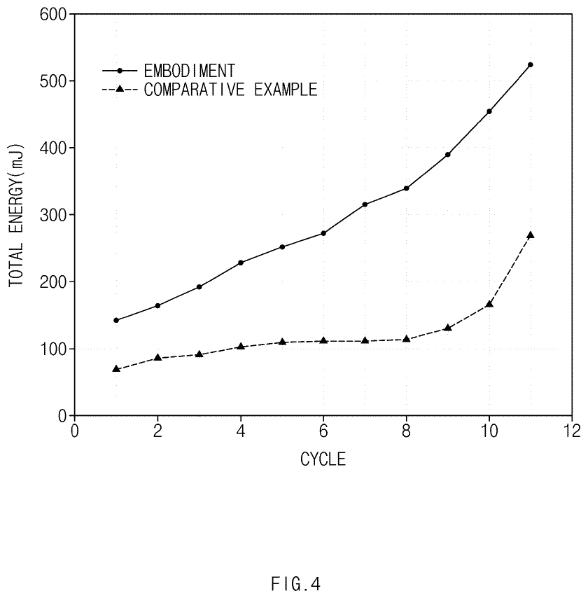

In addition, the powder transfer energy was measured through the following manner with respect to the electrode mixtures according to the embodiment and the comparative example, and the power transfer energy as a function of a cycle is illustrated in FIG. 4.

### [Measurement Manner]

Power transfer energy (Eₜₒₜₐₗ): the power transfer energy was measured, the electrode mixture was filled in the 25 mL vessel and then torque and force were measured by rotating the blade through FT4 Powder Rheometer (Micromeritics). Then, the result was substituted into following Equation 2 to calculate a powder transfer energy value. In this case, the blade was rotated eight times at 100 rpm, one time at 70 rpm, one time at 40 rpm, and one time at 10 rpm.

$$Powder transfer energy ( {E}_{total} [ mJ ] ) = {\int }_{0}^{H} ( \frac{T}{Rtana} + F ) dH \qquad [ Equation 2 ]$$

In Equation 2, ‘H’ denotes a measured depth [mm], ‘a’ denotes a spiral angle [°], ‘T’ denotes the torque applied to the blade [N·mm], ‘R’ denotes the diameter of the blade [mm], and ‘F’ denotes the measured force [N]. According to the present experiment, ‘H’ was set to 55 m, ‘a’ was set to 5°, and ‘R’ was set to 23.5 mm.

It may be recognized through FIG. 4, that the electrode mixture according to an embodiment of the present disclosure exhibited lower powder transfer energy than the power transfer energy of the electrode mixture according to the Comparative example. In other words, it may be recognized that lower cohesion was exhibited.

It may be recognized through the above-described result that the solid electrolyte crystallized as in the present disclosure may reduce the cohesion with the binder. Accordingly, it may be recognized that the dispersibility of the electrode mixture may be improved, such that the solid electrolyte crystallized according to the present disclosure was appropriate to the dry electrode.

### Experimental Example 3: Cell Evaluation of Cathode

A battery was manufactured using the cathode, the carbon-based anode, and the LPSCl-based solid electrolyte prepared according to the embodiment and the Comparative example, and the charging/discharging capacity and efficiency during three cycles were measured with respect to the prepared battery, and then the result was shown in the following Table 2. In detail, the charging/discharging was performed under the conditions of 30 °C and 0.2 C and the charging/discharging capacity [mAh/g] was measured. In addition, Coulombic Efficiency [%] was calculated

TABLE 2

| | Embodiment | | | Comparative example | | |
|---|---|---|---|---|---|---|
| | Charging | Discharging | Coulombic | Charging | Discharging | Coulombic |
| | capacity | capacity | Efficiency | capacity | capacity | Efficiency |
| | [mAh/g] | [mAh/g] | [%] | [mAh/g] | [mAh/g] | [%] |
| Cycle 1 | 209.2 | 197.2 | 94.3 | 202.3 | 191.0 | 94.4 |
| Cycle 2 | 196.9 | 191.8 | 97.4 | 192.0 | 189.0 | 98.4 |
| Cycle 3 | 194.0 | 191.8 | 98.9 | 190.3 | 188.0 | 98.7 |

It may be recognized from Table 2 that the cathode manufactured according to an embodiment of the present disclosure had higher charging/discharging capacity that of the charging/discharging capacity of the cathode manufactured according to the Comparative example.

Accordingly, when the crystalline solid electrolyte according to the present disclosure is employed for the dry electrode, the dispersibility may be improved due to low cohesion between the solid electrolyte and the binder. Accordingly, the all-solid-state battery including the electrode according to the present disclosure may have higher capacity, and may maintain higher charging capacity even if a cycle is repeated, thereby improving the stability.

According to the present disclosure, the electrode mixture may include the crystalline solid electrolyte exhibiting the lower cohesion with the fibrous binder. Accordingly, when compared to the conventional mixture, the dispersibility may be improved. Accordingly, the cathode manufactured from the electrode mixture according to the present disclosure may be improved in mechanical strength and the electrochemical performance.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A dry electrode mixture comprising:
a crystalline solid electrolyte, an active material, and a fibrous binder,
wherein the crystalline solid electrolyte has a sheer stress ranging from 1.0 kPa to 2.8 kPa under 2 kPa.

2. The dry electrode mixture of claim 1, wherein a solvent is substantially absent in the dry electrode mixture.

3. The dry electrode mixture of claim 1, wherein the crystalline solid electrolyte comprises a sulfide-based solid electrolyte.

4. The dry electrode mixture of claim 1, wherein the crystalline solid electrolyte has a flow function (FF) ranging from 4 to 7.

5. The dry electrode mixture of claim 1, wherein the crystalline solid electrolyte has an angle of internal friction ranging from 40° to 60°.

6. The dry electrode mixture of claim 1, wherein the crystalline solid electrolyte has a bulk density ranging from 0.40 g/ml to 0.58 g/ml.

7. The dry electrode mixture of claim 1, wherein the active material has a content ranging from 70 wt % to 90 wt %, based on a total weight of the dry electrode mixture.

8. The dry electrode mixture of claim 1, wherein the active material has a content ranging from 10 wt % to 20 wt %, based on a total weight of the dry electrode mixture.

9. The dry electrode mixture of claim 1, wherein the fibrous binder has a content ranging from 0.1 wt % to 5.0 wt %, based on a total weight of the dry electrode mixture.

10. The dry electrode mixture of claim 1, wherein the fibrous binder includes:
at least one selected from polytetrafluoroethylene (PTFE), polyvinylidene fluoride (PVDF), and a copolymer of PTFE or PVDF.

11. The dry electrode mixture of claim 1, wherein a degree of fibrillation calculated through following Equation 1 is at least 2,
Degree of Fibrillation=(powder transfer energy at 11-th cycle−powder transfer energy in first cycle)/10, [Equation 1]
in which the powder transfer energy in the Equation 1 is a value calculated through following Equation 2, when a mixture is fully filled in a vessel including a blade,
$${E}_{total} ( powder transfer energy [ mJ ] ) = {\int }_{0}^{H} ( \frac{T}{Rtana} + F ) dH \qquad [ Equation 2 ]$$
in which, in Equation 2, ‘H’ denotes a measured depth [mm], ‘a’ denotes a spiral angle [°], ‘T’ denotes the torque applied to the blade [N·mm], ‘R’ denotes the diameter of the blade [mm], and ‘F’ denotes the measured force [N].

12. The dry electrode mixture of claim 1, wherein the active material is a cathode active material.

13. A cathode comprising:
a cathode active material, a crystalline solid electrolyte, and a fibrous binder having a network,
wherein the crystalline solid electrolyte has a sheer stress ranging from 1.0 kPa to 2.8 kPa under 2 kPa.

14. An all-solid-state battery comprising:
a cathode according to claim 13 and an anode.

15. A method for manufacturing an electrode, the method comprising:
mixing a crystalline solid electrolyte, an active material, and a fibrous binder under absence of a solvent to prepare an electrode mixture,
forming an electrode film by pressing the electrode mixture; and
attaching the electrode film to a metal current collector,
wherein the crystalline solid electrolyte has a sheer stress ranging from 1.0 kPa to 2.8 kPa under 2 kPa.

16. The method of claim 15, wherein the pressing is performed through a roll pressing manner.

17. The method of claim 15, wherein the pressing is performed at a temperature ranging from 60 °C to 120 °C.

18. The method of claim 15, wherein the attaching is performed through a roll pressing manner.

19. The method of claim 15, wherein the attaching is performed at a temperature ranging from 40 °C to 100 °C.
